(19) United States
(12) Patent Application Publication
(10) Pub. No.: US 2023/0358875 A1
(43) Pub. Date: Nov. 9, 2023

(54) OBJECT SCANNING DEVICE, CONTROL CIRCUIT, STORAGE MEDIUM, AND OBJECT SCANNING METHOD

(71) Applicant: Mitsubishi Electric Corporation, Tokyo (JP)

(72) Inventors: Michiya HAYAMA, Tokyo (JP); Akinori TAIRA, Tokyo (JP); Kazuaki ISHIOKA, Tokyo (JP)

(73) Assignee: Mitsubishi Electric Corporation, Tokyo (JP)

(21) Appl. No.: 18/223,319

(22) Filed: Jul. 18, 2023

Related U.S. Application Data
(63) Continuation of application No. PCT/JP2021/003238, filed on Jan. 29, 2021.

(51) Int. Cl. G01S 13/42; G01S 13/90; G01S 7/02; G01S 7/298

(52) U.S. Cl. CPC G01S 13/426; G01S 13/9021; G01S 13/9005; G01S 7/024; G01S 7/298

(57) ABSTRACT

An object scanning device generates an image of a radio wave scatterer that is a measurement subject disposed in a measurement area based on reflected waves of radio waves including a plurality of frequencies radiated to the radio wave scatterer, and includes a phase composite image generation unit that generates a phase composite image into which a plurality of images obtained through imaging based on the reflected waves are composed by performing complex addition for each pixel of the plurality of images.

### CROSS-REFERENCE TO RELATED APPLICATION

This application is a continuation application of International Application PCT/JP2021/003238, filed on Jan. 29, 2021, and designating the U.S., the entire contents of which are incorporated herein by reference.

### BACKGROUND OF THE INVENTION

### 1. Field of the Invention

The present disclosure relates to an object scanning device, a control circuit, a storage medium, and an object scanning method for scanning an object.

### 2. Description of the Related Art

An object scanning device that performs imaging of an object using a matched filter (MF) is a type of device that radiates millimeter waves, terahertz waves, or the like to an object that is a measurement subject, and sees through the object using reflected waves from the object. This object scanning device radiates radio waves to an object while moving the transmission and reception antennas for measurement according to a predetermined path, receives reflected waves from scattering points of the object, and records time-series data of the reflected waves.

The object scanning device generates the reception waveform, i.e. the waveform of the reception signal, by superimposing the reflected waves having various waveforms received from various scattering points. Here, if the positional relationship between the measurement area and the transmission and reception antennas is known, the object scanning device can estimate the waveform of the reflected wave from the scattering point at given coordinates on the measurement area. When performing MF-based imaging, the object scanning device comprehensively provides observation points in the measurement area, generates an estimated waveform of a reflected wave for each observation point, and correlates the estimated waveform with the reception waveform, thereby mapping the reflection intensity from each observation point. In this case, the correlation value between the estimated waveform and the reception waveform is obtained as a correlation vector having phase information. That is, the correlation vector indicates the correlation between the estimated waveform and the reception waveform and has phase information. The object scanning device can obtain a high correlation value when the observation point and the scattering point are close to each other, and can obtain a low correlation value when the scattering point does not exist near the observation point.

When performing MF-based imaging, the object scanning device can reduce side lobes due to the arrangement of the transmission and reception antennas and scattering objects around the measurement area by repeating the same measurement using radio waves of a plurality of frequencies. As methods for composing images measured with radio waves of a plurality of frequencies, there are a method of power composing type that performs integration of the magnitude of correlation vectors for each pixel and a method of phase composing type that performs complex addition in which phase information for each pixel is considered.

The method of phase composing type can produce a higher side lobe reduction effect than the method of power composing type, but may result in cancellation of correlation vectors at the time of complex addition unless the phases of the correlation vectors of the same observation point measured with radio waves of different frequencies are accurately matched. Therefore, the method of phase composing type requires signal processing in which information on the positional relationship between the observation points and the transmission and reception antennas or the influence of the frequency characteristics of the measurement system is considered.

A possible way to implement phase composing is to estimate or preliminarily measure by some means a phase offset that occurs when a certain pixel is measured with radio waves of different frequencies, and subtract the phase offset from the measurement result for phase correction. The millimeter wave image processing device described in Japanese Patent Application Laid-open No. 2007-256171 includes a signal processing device that performs signal processing of a signal received using an antenna, and a calibration signal generation device disposed in the outside of the signal processing device. The calibration signal generation device acquires phase offset information that is applied to the signal processing device, and the signal processing device corrects the phase of radio waves received by the antenna using the phase offset information.

However, the technique of Japanese Patent Application Laid-open No. 2007-256171, which requires the calibration signal generation device, is problematic in terms of device configuration complexity.

### SUMMARY OF THE INVENTION

In order to solve the above problem, the present disclosure that generates an image of a measurement subject disposed in a measurement area based on reflected waves of radio waves including a plurality of frequencies radiated to the measurement subject, the present disclosure includes: a phase composite image generation unit to generate a phase composite image into which a plurality of images obtained through imaging based on the reflected waves are composed by performing complex addition for each pixel of the plurality of images.

### BRIEF DESCRIPTION OF THE DRAWINGS

FIG. 1 is a diagram illustrating a configuration of an object scanning device according to a first embodiment;

FIG. 2 is a diagram for explaining another example of an antenna moving path applied by the object scanning device according to the first embodiment;

FIG. 3 is a diagram for explaining a process of generating a reception signal by the object scanning device according to the first embodiment;

FIG. 4 is a diagram for explaining observation points set by the object scanning device according to the first embodiment;

FIG. 5 is a diagram for explaining the correlation between estimated waveforms of reflected waves and a reception waveform calculated by the object scanning device according to the first embodiment;

FIG. 6 is a diagram for explaining an update pattern for the frequencies of high frequency signals used by the object scanning device according to the first embodiment;

FIG. 7 is a diagram for explaining a configuration of the quadrature detection unit provided in the object scanning device according to the first embodiment;

FIG. 8 is a diagram illustrating a configuration of the waveform recording unit provided in the object scanning device according to the first embodiment;

FIG. 9 is a diagram for explaining a process of generating a power composite image by the power composite image generation unit provided in the object scanning device according to the first embodiment;

FIG. 10 is a diagram for explaining a process of calculating a correction phase at each frequency by the correction phase calculation unit provided in the object scanning device according to the first embodiment;

FIG. 11 is a diagram for explaining a process of generating a phase composite image by the phase composite image generation unit provided in the object scanning device according to the first embodiment;

FIG. 12 is a flowchart illustrating a procedure for generating a phase composite image by the object scanning device according to the first embodiment;

FIG. 13 is a diagram illustrating a configuration of an object scanning device according to a second embodiment;

FIG. 14 is a flowchart illustrating a procedure for generating a phase composite image by an object scanning device according to a third embodiment;

FIG. 15 is a diagram for explaining combinations that are sets of observation coordinates and the sum of Euclidean distances in each combination calculated by the object scanning device according to the third embodiment;

FIG. 16 is a diagram illustrating an exemplary configuration of processing circuitry in the case that the processing circuitry provided in the object scanning device according to the first embodiment is implemented by a processor and a memory; and

FIG. 17 is a diagram illustrating an example of processing circuitry in the case that the processing circuitry provided in the object scanning device according to the first embodiment is implemented by dedicated hardware.

### DETAILED DESCRIPTION OF THE PREFERRED EMBODIMENTS

Hereinafter, an object scanning device, a control circuit, a storage medium, and an object scanning method according to embodiments of the present disclosure will be described in detail with reference to the drawings.

### First Embodiment

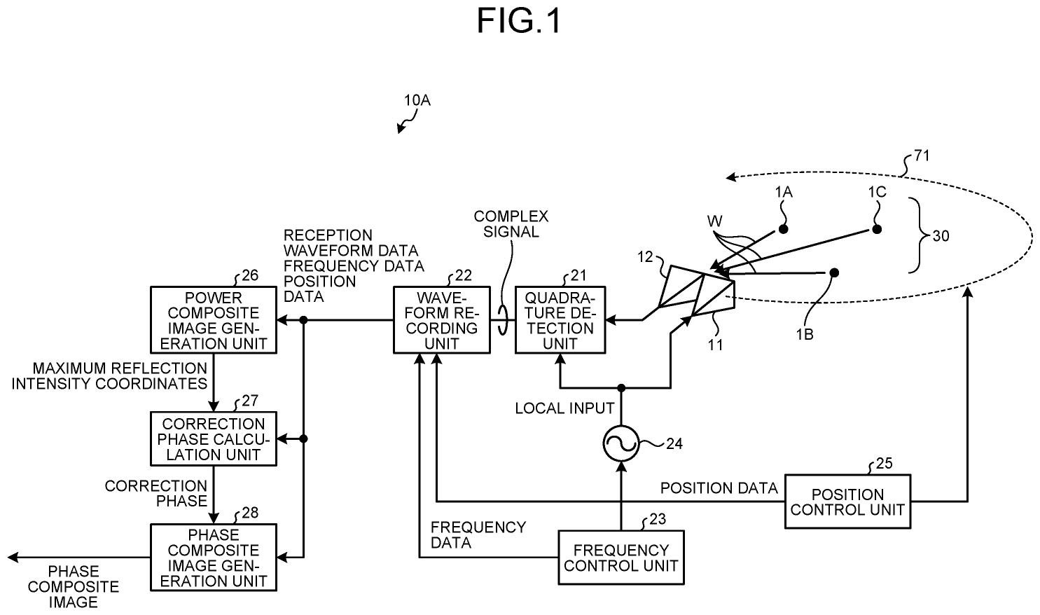

FIG. 1 is a diagram illustrating a configuration of an object scanning device according to the first embodiment. The object scanning device 10A is a device that radiates radio waves of high frequency signals such as millimeter waves or terahertz waves to a radio wave scatterer (object) 30 that is a measurement subject, and scans (or sees through) the radio wave scatterer 30 using reflected waves W from the radio wave scatterer 30. The object scanning device 10A scans the radio wave scatterer 30 through MF-based imaging. The object scanning device 10A executes MF by means of the method of phase composing type using high frequency signals of a plurality of frequencies. Note that the first embodiment assumes that the object scanning device 10A scans the radio wave scatterer 30 under an environment where an accurate distance to the radio wave scatterer 30 cannot be measured.

The object scanning device 10A includes a transmission antenna 11, a reception antenna 12, a quadrature detection unit 21, a high frequency signal generation unit 24, a waveform recording unit 22, a position control unit 25, and a frequency control unit 23. The object scanning device 10A also includes a power composite image generation unit 26, a correction phase calculation unit 27, and a phase composite image generation unit 28. Note that the transmission antenna 11 may be a structure separate from the object scanning device 10A. The reception antenna 12 may also be a structure separate from the object scanning device 10A.

The frequency control unit 23 controls the frequency of a high frequency signal to be output from the high frequency signal generation unit 24 by outputting a frequency command specifying the frequency of a high frequency signal to the high frequency signal generation unit 24. The frequency control unit 23 updates, with a predetermined pattern, the frequency of a high frequency signal specified to the high frequency signal generation unit 24. The frequency control unit 23 outputs the frequency of a high frequency signal indicated by the frequency command to the waveform recording unit 22 as frequency data.

The high frequency signal generation unit 24 generates a high frequency signal for use in measurement in accordance with the frequency command from the frequency control unit 23, and outputs the high frequency signal to the transmission antenna 11 and the quadrature detection unit 21.

The output of the high frequency signal generation unit 24 is coupled to the local input of the quadrature detection unit 21 and the local input of the transmission antenna 11. The high frequency signal generation unit 24 supplies high frequency signals of various frequencies to the transmission antenna 11 and the quadrature detection unit 21. An example of the high frequency signal generation unit 24 is a high frequency signal generator.

The transmission antenna 11 is a component that emits the high frequency signal output from the high frequency signal generation unit 24 into space as radio waves. The transmission antenna 11 radiates radio waves of the high frequency signal to the radio wave scatterer 30 to be measured. Examples of the transmission antenna 11 include a horn antenna, a pattern antenna formed on a substrate, an array antenna including a plurality of antennas, and the like.

The reception antenna 12 is a component that receives the reflected waves W from the radio wave scatterer 30. The reception antenna 12 receives the reflected waves W reflected by a plurality of radio wave scattering points such as scattering points 1A to 1C, and outputs the reflected waves W to the quadrature detection unit 21. Examples of the reception antenna 12 include a horn antenna, a pattern antenna formed on a substrate, an array antenna including a plurality of antennas, and the like. Note that the reception antenna 12 need not necessarily have the same structure as the transmission antenna 11.

The position control unit 25 controls at least one of the position of the transmission antenna 11 and the position of the reception antenna 12. The position control unit 25 may control the positions of both the transmission antenna 11 and the reception antenna 12, may control the position of only the transmission antenna 11, or may control the position of only the reception antenna 12.

If the position of the reception antenna 12 is fixed, the position control unit 25 controls the position of the transmission antenna 11. If the position of the transmission antenna 11 is fixed, the position control unit 25 controls the position of the reception antenna 12.

The position of the transmission antenna 11 corresponds to the direction in which the transmission antenna 11 emits radio waves. Hereinafter, a case where the position control unit 25 controls the positions of both the transmission antenna 11 and the reception antenna 12 will be described. In addition, the relative position between the transmission antenna 11 and the reception antenna 12 does not change, and the position control unit 25 moves the transmission antenna 11 and the reception antenna 12 together.

The position control unit 25 is connected to a conveyance mechanism (not illustrated) equipped with the transmission antenna 11 and the reception antenna 12, and controls the position of the transmission antenna 11 and the reception antenna 12 by controlling the position of the conveyance mechanism.

The position control unit 25 moves the transmission antenna 11 and the reception antenna 12 according to a predetermined antenna moving path 71, and outputs position data indicating the position of the transmission antenna 11 and the reception antenna 12 to the waveform recording unit 22. If the position of the transmission antenna 11 is fixed, the position data of the transmission antenna 11 has a fixed value. If the position of the reception antenna 12 is fixed, the position data of the reception antenna 12 has a fixed value. The position data output from the position control unit 25 to the waveform recording unit 22 corresponds to a movement command output from the position control unit 25 to the conveyance mechanism.

For example, as illustrated in FIG. 1, the antenna moving path 71 is a path along a circle of movement surrounding the radio wave scatterer 30 to be measured. Note that the antenna moving path 71 is not limited to a path along a circle.

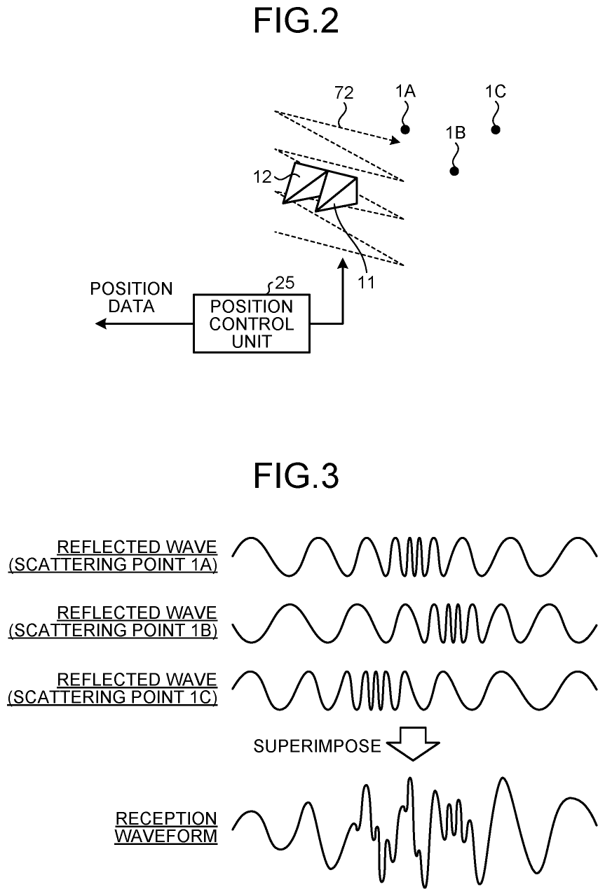

FIG. 2 is a diagram for explaining another example of an antenna moving path applied by the object scanning device according to the first embodiment. The antenna moving path 72, which is another example of the antenna moving path 71, is a path along which the transmission antenna 11 and the reception antenna 12 move up, down, left, and right in a specific plane. Assuming that the plane set for the antenna moving path 72 is an XY plane, the position control unit 25 moves the transmission antenna 11 and the reception antenna 12 in various directions in the XY plane by combining various movements in the X direction and in the Y direction.

In the case of applying the antenna moving path 72, the object scanning device 10A uses an XY stage that moves the transmission antenna 11 and the reception antenna 12 in the XY plane. The XY stage is a stage movable in the X-axis direction and the Y-axis direction, where the X axis and the Y axis are two axes that are in a specific plane and are orthogonal to each other.

The quadrature detection unit 21 down-converts the reception signal obtained from the reception antenna 12 using the high frequency signal supplied from the high frequency signal generation unit 24 to obtain a baseband signal that is a complex signal. The baseband signal includes amplitude/phase difference information, i.e. information of the amplitude difference and the phase difference between the high frequency signal output from the transmission antenna 11 and the reflected waves received by the reception antenna 12. The quadrature detection unit 21 outputs the baseband signal including the amplitude/phase difference information to the waveform recording unit 22. An example of the quadrature detection unit 21 is a quadrature detection circuit.

The waveform recording unit 22 converts the baseband signal output from the quadrature detection unit 21 from analog to digital to obtain a reception waveform data, and records the reception waveform data. The waveform recording unit 22 records the reception waveform data including the amplitude/phase difference information, the frequency data, and the position data in association with each other.

The power composite image generation unit 26 uses the reception waveform data, frequency data, and position data recorded in the waveform recording unit 22 to generate a power composite image of the radio wave scatterer 30 to be measured by means of an imaging method using a MF (i.e. an MF-based imaging method) of power composing type. The power composite image is an image generated with an MF-based imaging method of power composing type.

The method of power composing type is a method of calculating a correlation value between an estimated waveform and a reception waveform, that is, a correlation vector having phase information, for each frequency with respect to all observation points, and integrating only the magnitude of the obtained correlation vectors. The method of power composing type is advantageous in that regardless of whether the phases of correlation vectors vary, imaging can be performed robustly because the phases are not considered.

Among the coordinates on the power composite image generated by the power composite image generation unit 26, a coordinate indicating a position of an observation point having the maximum reflection intensity is called a maximum reflection intensity coordinate. The power composite image generation unit 26 outputs data of the power composite image including the maximum reflection intensity coordinate to the correction phase calculation unit 27.

The correction phase calculation unit 27 calculates a correction phase Arg(cₙ(λ)) at each frequency based on the power composite image output from the power composite image generation unit 26 and the reception waveform data, frequency data, and position data recorded in the waveform recording unit 22. In this case, the correction phase calculation unit 27 searches the power composite image output from the power composite image generation unit 26 for the maximum reflection intensity coordinate, and calculates the correction phase Arg(cₙ(λ)) at the maximum reflection intensity coordinate for each frequency. The correction phase calculation unit 27 outputs the correction phase Arg(cₙ(λ)) at each frequency to the phase composite image generation unit 28.

The phase composite image generation unit 28 generates a phase composite image based on the correction phase Arg(cₙ(λ)) at each frequency output from the correction phase calculation unit 27 and the reception waveform data, frequency data, and position data recorded in the waveform recording unit 22. In this case, the phase composite image generation unit 28 generates the phase composite image with an imaging method of phase composing type. The phase composite image is an image generated with an MF-based imaging method of phase composing type. The phase composite image generation unit 28 outputs the phase composite image as an imaging result to an external device such as a display device.

Here, the relationship between time-series data of reflected waves obtained by the measurement system of the object scanning device 10A and a reception signal will be described. FIG. 3 is a diagram for explaining a process of generating a reception signal by the object scanning device according to the first embodiment.

As illustrated in FIG. 3, reflected waves from the scattering points 1A to 1C at different positions have different waveforms. The reception antenna 12 generates a reception signal by superimposing time-series data of the reflected waves. Here, the reception antenna 12 generates the reception waveform, i.e. the waveform of the reception signal, by superimposing the reflected wave from the scattering point 1A, the reflected wave from the scattering point 1B, and the reflected wave from the scattering point 1C. Thus, the reception signal is a signal in which the reflected waves from all the scattering points are superimposed.

In this case, if the positional relationship between the position of the measurement area in which the scattering points are disposed and the transmission/reception antenna position, which is the position of the transmission antenna 11 and the reception antenna 12, is known, it is possible to estimate the waveform of the reflected wave from the scattering point at given coordinates on the measurement area. The position of the measurement area is registered in the object scanning device 10A in advance. The transmission/reception antenna position corresponds to the position data that the position control unit 25 causes the waveform recording unit 22 to record.

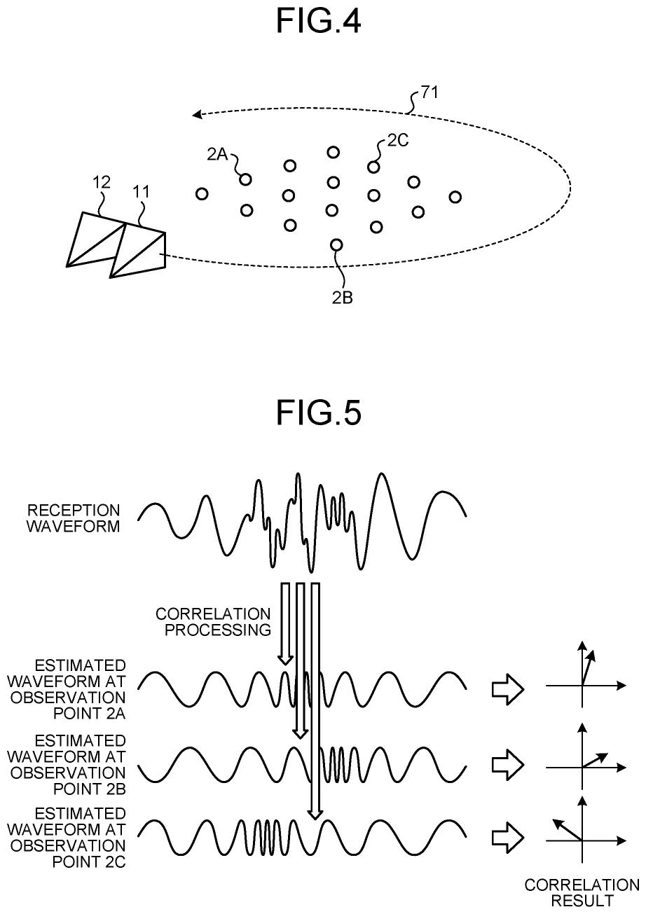

When performing MF-based imaging, the object scanning device 10A comprehensively provides observation points in the measurement area, and generates an estimated waveform of a reflected wave for each observation point. FIG. 4 is a diagram for explaining observation points set by the object scanning device according to the first embodiment.

The object scanning device 10A comprehensively sets observation points at various positions in the measurement area. FIG. 4 illustrates a case where the object scanning device 10A sets observation points 2A to 2C.

The object scanning device 10A maps the reflection intensity from each observation point by correlating the estimated waveforms of reflected waves with the reception waveform. FIG. 5 is a diagram for explaining the correlation between estimated waveforms of reflected waves and a reception waveform calculated by the object scanning device according to the first embodiment.

The power composite image generation unit 26 of the object scanning device 10A correlates the estimated waveforms of reflected waves with the reception waveform. Here, the power composite image generation unit 26 correlates the estimated waveform of the reflected wave at the observation point 2A with the reception waveform. In addition, the power composite image generation unit 26 correlates the estimated waveform of the reflected wave at the observation point 2B with the reception waveform, and correlates the estimated waveform of the reflected wave at the observation point 2C with the reception waveform.

The power composite image generation unit 26 maps the reflection intensity from each observation point based on the correlation result indicating the correlation value between the estimated waveform of the reflected wave and the reception waveform. The correlation value in this case is obtained as a correlation vector having phase information. When the distance between the observation point and the scattering point is short, a high correlation value is obtained, and when the scattering point does not exist near the observation point, a low correlation value is obtained.

In the MF-based imaging executed by the object scanning device 10A, by repeating the same measurement using a plurality of frequencies, it is possible to reduce side lobes due to the arrangement of the transmission antenna 11 and the reception antenna 12 and scattering objects around the radio wave scatterer 30.

When composing images measured at a plurality of frequencies, the object scanning device 10A uses both the method of power composing type that involves integration of the magnitude of correlation vectors for each pixel and the method of phase composing type that involves complex addition in which phase information for each pixel is considered.

The method of phase composing type may result in cancellation of correlation vectors at the time of complex addition unless the phases of the correlation vectors of the same observation point measured at different frequencies are accurately matched; therefore, the object scanning device 10A executes signal processing by considering the positional relationship between the position of observation points and the transmission/reception antenna position and the influence of the frequency characteristics of the measurement system.

Here, a process of generating a phase composite image executed by the object scanning device 10A will be briefly described. When composing the images measured at a plurality of frequencies by means of the method of phase composing type, the object scanning device 10A removes the phase offset included in the observation system so as to match the phases of the correlation vectors of the same observation point measured at different frequencies. That is, in order to implement phase composing, the object scanning device 10A corrects the phase of radio waves by subtracting the phase offset of correlation vectors that occurs when a certain pixel is measured at different frequencies from the phase of the measurement result.

In the measurement system illustrated in FIG. 4, given that the round-trip propagation distance at time t between the transmission/reception antenna position and a certain observation point n is dₙ(t), the phase θ(t, λ) of the reception signal is expressed by Formula (1) below. The wavelength of radio waves used for the measurement is the wavelength λ, and the fixed phase offset amount included in the measurement system at the wavelength λ is φ(λ).

$$\begin{matrix}Formula 1 : & \\ θ ( τ , λ ) = \frac{{d}_{n} ( t )}{λ} + ϕ ( λ ) & ( 1 )\end{matrix}$$

In addition, the estimated value θ^{λ}(t, λ) of the reflected wave phase from the observation point n at time t in which the fixed phase offset included in the measurement system is not considered is expressed by Formula (2) below. The symbol θ^{λ} indicates that a hat symbol is placed directly above “θ”. The fixed error between the actual distance between the transmission/reception antenna position and the observation point and the estimated value is E.

$$\begin{matrix}Formula 2 : & \\ \hat{θ} ( τ , λ ) = \frac{{d}_{n} ( t ) + E}{λ} & ( 2 )\end{matrix}$$

The reflected wave yₙ(t, λ) from the observation point n at time t and its estimated value yₙ^{λ}(t, λ) are expressed respectively by Formulas (3) and (4) below using Formulas (1) and (2). The symbol yₙ^{λ} indicates that a hat symbol is placed directly above “yₙ”.

Formula 3:

yₙ(t,λ)=exp{−jθ(t,λ)} (3)

Formula 4:

ŷₙ(t,λ)=exp{−j\hat{θ}(t,λ)} (4)

Note that for simplification of the conditions, the amplitude variation of reflected waves is assumed to be negligible. In this case, the correlation value cₙ(λ) at the wavelength λ and the observation point n is expressed by Formula (5) below.

$$\begin{matrix}Formula 5 : & \\ \begin{matrix}{c}_{n} ( λ ) = {\int }_{0}^{r} {y}_{n} ( t , λ ) {\hat{y}}_{u}^{*} ( t , λ ) dt = {\int }_{0}^{r} exp [ - j \{ \frac{{d}_{n} ( t )}{λ} + ϕ ( λ ) - \frac{{d}_{n} ( t ) + E}{λ} \} ] dt \\ = T exp [ - j \{ ϕ ( λ ) - \frac{E}{λ} \} ]\end{matrix} & ( 5 )\end{matrix}$$

Formula (5) indicates that the phase component of the correlation vector at each observation point depends only on the wavelength λ of radio waves used for measurement, and does not depend on the location of the observation point. Therefore, the object scanning device 10A according to the present embodiment takes advantage of the fact that the phase component of the correlation vector at each observation point depends only on the wavelength λ of radio waves used for measurement and does not depend on the location of the observation point. The object scanning device 10A calculates, for each frequency, the phase Arg(cₙ(λ)) of the correlation vector at the coordinates (calibration coordinates) from which a reflection intensity larger than a specific value is obtained in the measurement area, and uses the phase Arg(cₙ(λ)) as a correction phase for composing the frequencies.

The object scanning device 10A generates a phase composite image by correcting the images at different frequencies using the correction phase and composing the images. As a result, the object scanning device 10A avoids the cancellation of correlation vectors when composing the phases of the images acquired at different frequencies.

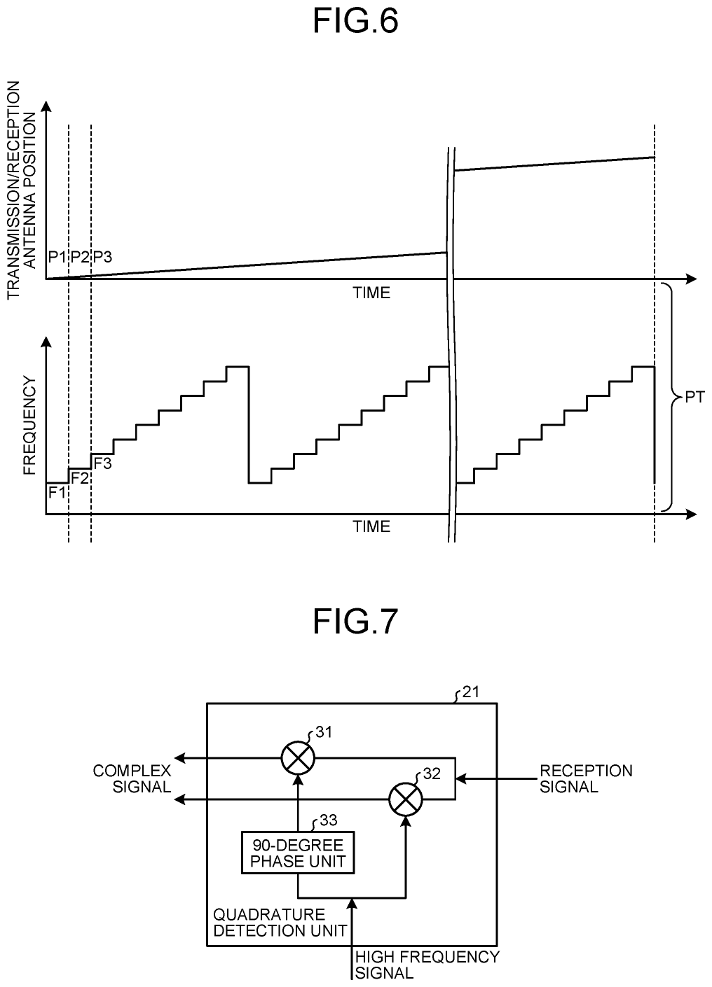

Hereinafter, the configuration and operation of each component included in the object scanning device 10A will be described in detail. FIG. 6 is a diagram for explaining an update pattern for the frequencies of high frequency signals used by the object scanning device according to the first embodiment. The horizontal axis of the graphs illustrated in FIG. 6 is time. The vertical axis of the graph illustrated in the upper part of FIG. 6 is the transmission/reception antenna position, and the vertical axis of the graph illustrated in the lower part of FIG. 6 is the frequency specified by the frequency control unit 23 to the high frequency signal generation unit 24.

The position control unit 25 moves the transmission antenna 11 and the reception antenna 12 at a constant speed. As illustrated in FIG. 6, the update pattern PT for the frequencies of high frequency signals can be a pattern in which frequencies in a certain range are repeated stepwise with respect to the transmission/reception antenna position set by the position control unit 25.

The graph illustrated in the upper part of FIG. 6 represents a case in which the position control unit 25 controls the position of the transmission antenna 11 and the reception antenna 12 so as to set the transmission/reception antenna position sequentially to the position P1, the position P2, and the position P3.

The graph illustrated in the lower part of FIG. 6 represents a case in which the frequency control unit 23 controls the frequency so as to increase the frequency stepwise to the frequency F1, the frequency F2, and the frequency F3. The frequency F1 is the frequency in the case that the transmission/reception antenna position is the position P1. The frequency F2 is the frequency in the case that the transmission/reception antenna position is the position P2, and the frequency F3 is the frequency in the case that the transmission/reception antenna position is the position P3.

After making the frequency reach a specific magnitude, the frequency control unit 23 performs control to increase the frequency stepwise again to the frequency F1, the frequency F2, and the frequency F3. The frequency control unit 23 repeats these processes.

Note that the update pattern PT illustrated in FIG. 6 is an example, and the combination of frequencies and transmission/reception antenna positions may be changed, or the order of measurement may be rearranged.

Here, a specific example of the quadrature detection unit 21 will be described. FIG. 7 is a diagram for explaining a configuration of the quadrature detection unit provided in the object scanning device according to the first embodiment. The quadrature detection unit 21 includes mixers 31 and 32 and a 90-degree phase unit 33. An example of the 90-degree phase unit 33 is a 90-degree phase shifter.

To the quadrature detection unit 21, the high frequency signal supplied from the high frequency signal generation unit 24 is locally input, and the reception signal is input from the reception antenna 12. The high frequency signal from the high frequency signal generation unit 24 is input to the 90-degree phase unit 33 and the mixer 32. The reception signal from the reception antenna 12 is input to the mixer 31 and the mixer 32.

The 90-degree phase unit 33 generates, from the high frequency signal, a high frequency signal having a phase difference of 90 degrees at the same frequency, and outputs the high frequency signal to the mixer 31. As a result, the high frequency signal from the high frequency signal generation unit 24 is input as it is to the mixer 32, and the high frequency signal having a phase difference of 90 degrees at the same frequency with respect to the high frequency signal from the high frequency signal generation unit 24 is input to the mixer 31.

The mixer 32 mixes the high frequency signal from the high frequency signal generation unit 24 and the reception signal and outputs the resultant signal. The mixer 31 mixes the high frequency signal having a phase difference of 90 degrees and the reception signal and outputs the resultant signal. As a result, the quadrature detection unit 21 down-converts the reception signal output from the reception antenna 12 to calculate a baseband signal (reception waveform data) that is a complex signal, and outputs the baseband signal to the waveform recording unit 22.

Next, the configuration and operation of the waveform recording unit 22 will be described in detail. The waveform recording unit 22 includes a memory unit that records reception waveform data that is a complex signal output from the quadrature detection unit 21, position data output from the position control unit 25, and frequency data output from the frequency control unit 23.

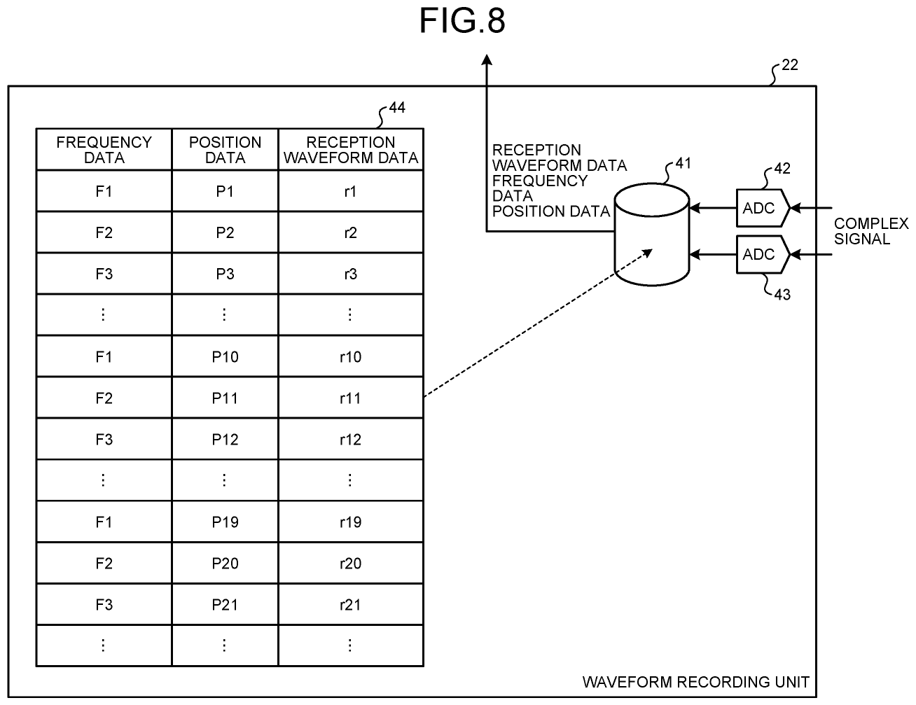

FIG. 8 is a diagram illustrating a configuration of the waveform recording unit provided in the object scanning device according to the first embodiment. The waveform recording unit 22 includes a memory unit 41 that stores correspondence information 44 in which reception waveform data indicated by a complex signal, frequency data, and position data are associated with each other.

The waveform recording unit 22 also includes analog-to-digital converters (ADCs) 42 and 43 that convert the complex signal output from the quadrature detection unit 21 into a digital signal and record the digital signal in the memory unit 41.

The ADC 42 converts the complex signal output from the mixer 31 of the quadrature detection unit 21 into a digital signal and records the digital signal in the memory unit 41. The ADC 43 converts the complex signal output from the mixer 32 of the quadrature detection unit 21 into a digital signal and records the digital signal in the memory unit 41.

The correspondence information 44 illustrated in FIG. 8 is information that is stored in the memory unit 41 when the transmission/reception antenna position and the frequency illustrated in FIG. 6 are set.

The frequency data, position data, and reception waveform data stored in the correspondence information 44 are read by the power composite image generation unit 26, the correction phase calculation unit 27, and the phase composite image generation unit 28. For example, the reception waveform r1 in the reception waveform data corresponds to the frequency F1 in the frequency data and the position P1 in the position data.

Next, the configuration and operation of the power composite image generation unit 26 will be described in detail. The power composite image generation unit 26 reads the reception waveform data, frequency data, and position data recorded in the waveform recording unit 22. The power composite image generation unit 26 generates a power composite image using the reception waveform data, frequency data, and position data recorded in the waveform recording unit 22.

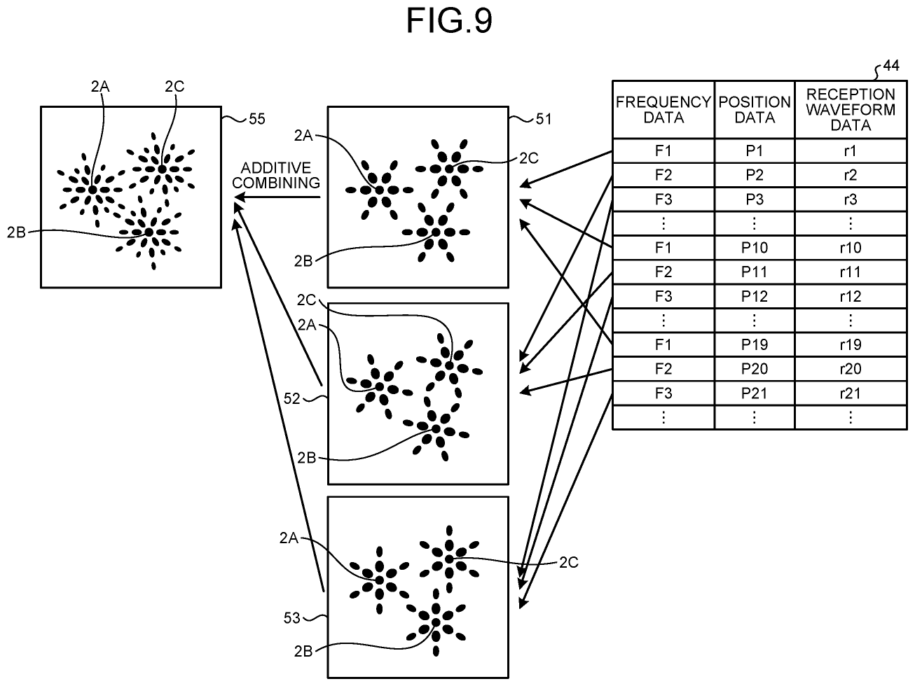

FIG. 9 is a diagram for explaining a process of generating a power composite image by the power composite image generation unit provided in the object scanning device according to the first embodiment. FIG. 9 illustrates the relationship between the correspondence information 44, which is data read from the waveform recording unit 22 by the power composite image generation unit 26, and the power composite image generated by the power composite image generation unit 26 using the read correspondence information 44.

The correspondence information 44 read from the waveform recording unit 22 by the power composite image generation unit 26 is information in which the reception waveform data, the frequency data, and the position data are associated with each other. The power composite image generation unit 26 groups the read correspondence information 44 into data pieces each having the same frequency, and generates an MF-based image for each frequency.

The illustrated case indicates that the power composite image generation unit 26 generates an image 51 from the data of the frequency F1, generates an image 52 from the data of the frequency F2, and generates an image 53 from the data of the frequency F3.

Thereafter, the power composite image generation unit 26 composes the images generated for the different frequencies by means of the method of power composing type to generate a single power composite image. FIG. 9 illustrates a case where the power composite image generation unit 26 composes the images 51 to 53 by means of the method of power composing type to generate a single power composite image 55.

Next, the configuration and operation of the correction phase calculation unit 27 will be described in detail. The correction phase calculation unit 27 calculates the correction phase Arg(cₙ(λ)) at each frequency based on the power composite image output from the power composite image generation unit 26 and the reception waveform data, frequency data, and position data recorded in the waveform recording unit 22.

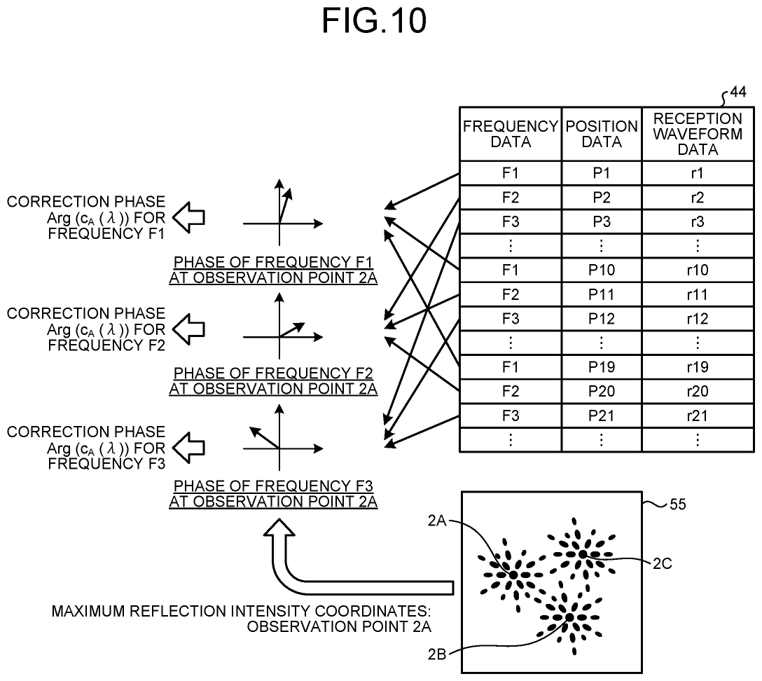

FIG. 10 is a diagram for explaining a process of calculating a correction phase at each frequency by the correction phase calculation unit provided in the object scanning device according to the first embodiment. FIG. 10 depicts a case where the correction phase calculation unit 27 calculates the correction phase Arg(cₙ(λ)) at each frequency using the power composite image 55 and the correspondence information 44.

The correction phase calculation unit 27 groups the read correspondence information 44 into data pieces each having the same frequency. The correction phase calculation unit 27 also searches for the maximum reflection intensity coordinate of the power composite image 55 output from the power composite image generation unit 26. Here, a case where the maximum reflection intensity coordinate represent the observation point 2A will be described.

The correction phase calculation unit 27 calculates, for each frequency, the correction phase Arg(cₙ(λ)) at the observation point 2A represented by the maximum reflection intensity coordinates. Specifically, the correction phase calculation unit 27 calculates the phases of the frequencies F1 to F3 at the observation point 2A. The phases of the frequencies F1 to F3 at the observation point 2A are used as the correction phases Arg(cₙ(λ)) for the images 51 to 53 when the power composite image 55 is generated.

That is, the phase Arg(cₙ(λ)) of the frequency F1 at the observation point 2A is used as the correction phase Arg(cₙ(λ)) for the image 51 when the power composite image 55 is generated. Similarly, the phase Arg(cₙ(λ)) of the frequency F2 at the observation point 2A is used as the correction phase Arg(cₙ(λ)) for the image 52 when the power composite image 55 is generated. The phase Arg(cₙ(λ)) of the frequency F3 at the observation point 2A is used as the correction phase Arg(cₙ(λ)) for the image 53 when the power composite image 55 is generated. In FIG. 10, the correction phases for the frequencies F1 to F3 are indicated by the correction phases Arg(c_{A}(λ)).

Next, the configuration and operation of the phase composite image generation unit 28 will be described in detail. The phase composite image generation unit 28 generates a phase composite image based on the correction phase Arg(cₙ(λ)) at each frequency output from the correction phase calculation unit 27 and the reception waveform data, frequency data, and position data recorded in the waveform recording unit 22.

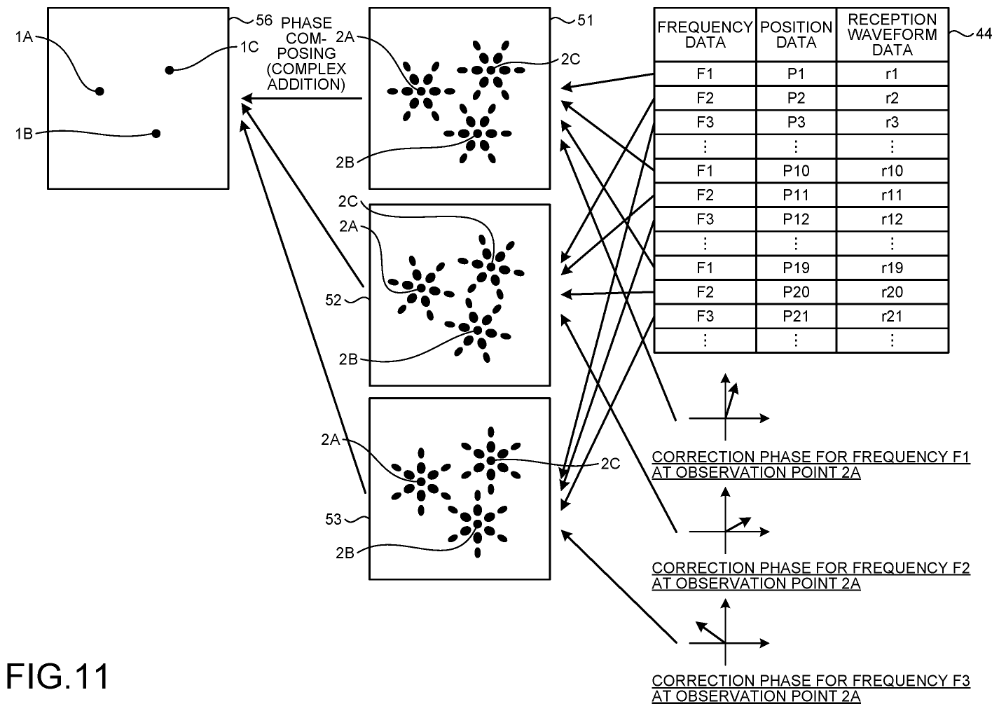

FIG. 11 is a diagram for explaining a process of generating a phase composite image by the phase composite image generation unit provided in the object scanning device according to the first embodiment. FIG. 11 depicts a case where the phase composite image generation unit 28 generates a phase composite image 56 using the correction phase Arg(cₙ(λ)) and the correspondence information 44.

The phase composite image generation unit 28 groups the correspondence information 44 read from the waveform recording unit 22 into data pieces each having the same frequency, and generates the images 51 to 53 using MF for the different frequencies. Note that the phase composite image generation unit 28 may acquire the images 51 to 53 at the different frequencies using MF from the power composite image generation unit 26.

The phase composite image generation unit 28 generates the phase composite image 56 from the images 51 to 53 created for the different frequencies by reversely rotating the correlation vector of each pixel by the correction phase Arg(cₙ(λ)) at each frequency calculated by the correction phase calculation unit 27, and performing complex addition. The phase composite image 56 corresponds to an image in the measurement area.

As described above, the object scanning device 10A calculates the phase Arg(cₙ(λ)) of the correlation vector for each frequency at the coordinate at which a reflection intensity larger than a specific value is obtained in the measurement area, for example, at the maximum reflection intensity coordinate. The object scanning device 10A uses the phase Arg(cₙ(λ)) as the correction phase Arg(cₙ(λ)), thereby avoiding the cancellation of correlation vectors when composing the images 51 to 53 acquired at different frequencies by means of the method of phase composing type.

In addition, as the calibration coordinates for obtaining the correction phase Arg(cₙ(λ)), the object scanning device 10A selects coordinate having a reflection intensity larger than a specific value, for example, maximum reflection intensity coordinate, from the images 51 to 53 generated through power composing. As a result, the object scanning device 10A can generate the phase composite image 56 in the measurement area using the correction phase Arg(cₙ(λ)) without disposing a calibration signal generation device in the measurement area and without installing a scatterer for calibration at known coordinates.

In addition, when the object scanning device 10A calibrates the phase of the images 51 to 53 created for different frequencies, it is not necessary for a calibration signal generation device to periodically generate calibration signals, and it is not necessary to stop the measurement of reflected waves during phase calibration. In addition, the object scanning device 10A does not require the installation of a radio frequency identification (RFID) tag, which is an example of a scatterer for calibration, at an accurate position in the measurement environment, and thus there is no restriction on the measurement environment.

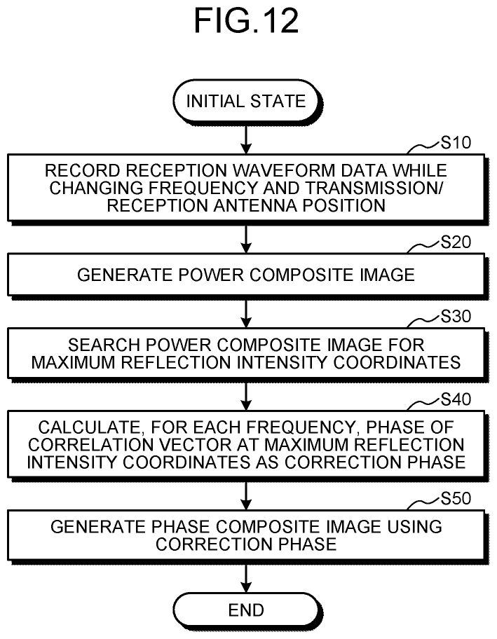

Next, a procedure for generating a phase composite image by the object scanning device 10A will be described. FIG. 12 is a flowchart illustrating a procedure for generating a phase composite image by the object scanning device according to the first embodiment. The object scanning device 10A receives reflected waves while changing the frequency and the transmission/reception antenna position, and records reception waveform data that is information of reflected waves (step S10).

Specifically, the position control unit 25 controls the transmission/reception antenna position, and the frequency control unit 23 controls the frequency. Upon receiving reflected waves from the radio wave scatterer 30, the reception antenna 12 outputs a reception signal to the quadrature detection unit 21. The quadrature detection unit 21 generates a baseband signal that is a complex signal using the reception signal from the reception antenna 12 and the high frequency signal from the high frequency signal generation unit 24.

The waveform recording unit 22 generates reception waveform data from the baseband signal and records the reception waveform data. In addition, the waveform recording unit 22 records the position data output from the position control unit 25 and the frequency data output from the frequency control unit 23 in association with the reception waveform data.

The power composite image generation unit 26 generates a power composite image using the reception waveform data, frequency data, and position data recorded in the waveform recording unit 22 (step S20).

The correction phase calculation unit 27 searches the power composite image for the maximum reflection intensity coordinates (step S30). The correction phase calculation unit 27 calculates, for each frequency, the phase of the correlation vector at the maximum reflection intensity coordinates as the correction phase (step S40). The phase composite image generation unit 28 generates a phase composite image using the correction phase (step S50).

As described above, in the first embodiment, the object scanning device 10A generates a phase composite image into which a plurality of images obtained through imaging based on the reflected waves from the radio wave scatterer 30 are composed by performing complex addition for each pixel of the plurality of images. As a result, the object scanning device 10A can obtain the correction phase amount for each frequency, which is required for composing the images measured using a plurality of frequencies by means of the method of phase composing type, without installing a calibration signal generation device in the measurement area or installing a scatterer for calibration at known coordinates. Therefore, even under an environment where an accurate distance to the radio wave scatterer 30 cannot be measured, the object scanning device 10A can accurately scan the radio wave scatterer 30 with a simple configuration using radio waves of a plurality of frequencies.

### Second Embodiment

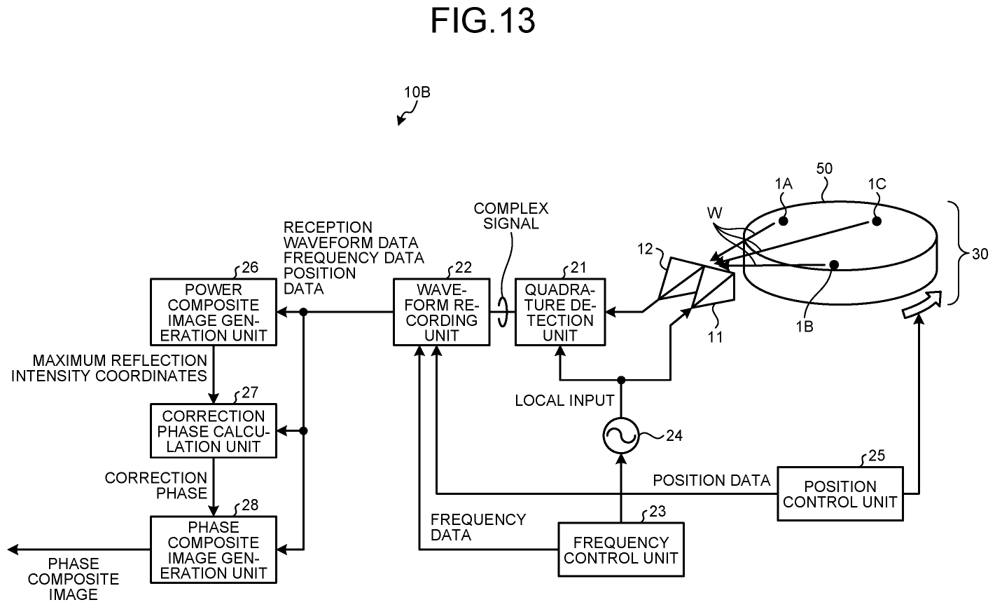

Next, the second embodiment will be described with reference to FIG. 13. In the second embodiment, the transmission antenna 11 and the reception antenna 12 are fixed, and the radio wave scatterer 30 is moved.

FIG. 13 is a diagram illustrating a configuration of an object scanning device according to the second embodiment. Components illustrated in FIG. 13 that achieve the same functions as those of the object scanning device 10A of the first embodiment illustrated in FIG. 1 are denoted by the same reference signs, and duplicate descriptions are omitted.

The object scanning device 10B is different from the object scanning device 10A in the measurement system. The object scanning device 10B fixes the transmission antenna 11 and the reception antenna 12, and instead moves the radio wave scatterer 30 that is a measurement subject. The object scanning device 10B includes a rotation table 50 that rotates with the measurement subject placed thereon.

The position control unit 25 of the object scanning device 10B controls the rotational position of the rotation table 50. As the rotation table 50 rotates, the radio wave scatterer 30 reflects radio waves at various positions. As a result, the reception antenna 12 of the object scanning device 10B receives the reflected waves W in the same manner as the object scanning device 10A. Therefore, the object scanning device 10B can generate a phase composite image through the same processing as the object scanning device 10A.

Although FIG. 13 illustrates the configuration in which the radio wave scatterer 30 is rotated by the rotation table 50, the object scanning device 10B may move the radio wave scatterer 30 using a mechanism such as the XY stage described in FIG. 2 of the first embodiment instead of the rotation table 50.

As described above, in the second embodiment, the object scanning device 10B rotates the radio wave scatterer 30 by means of the rotation table 50, and generates a phase composite image through the same processing as the object scanning device 10A. As a result, even under an environment where an accurate distance to the radio wave scatterer 30 cannot be measured, the object scanning device 10B can accurately scan the radio wave scatterer 30 with a simple configuration using radio waves of a plurality of frequencies, in the same manner as the object scanning device 10A.

In addition, owing to the fixed transmission/reception antenna position, the object scanning device 10B does not need to consider the movement of the wiring connecting the transmission antenna 11 and the high frequency signal generation unit 24 and the movement of the wiring connecting the reception antenna 12 and the quadrature detection unit 21.

### Third Embodiment

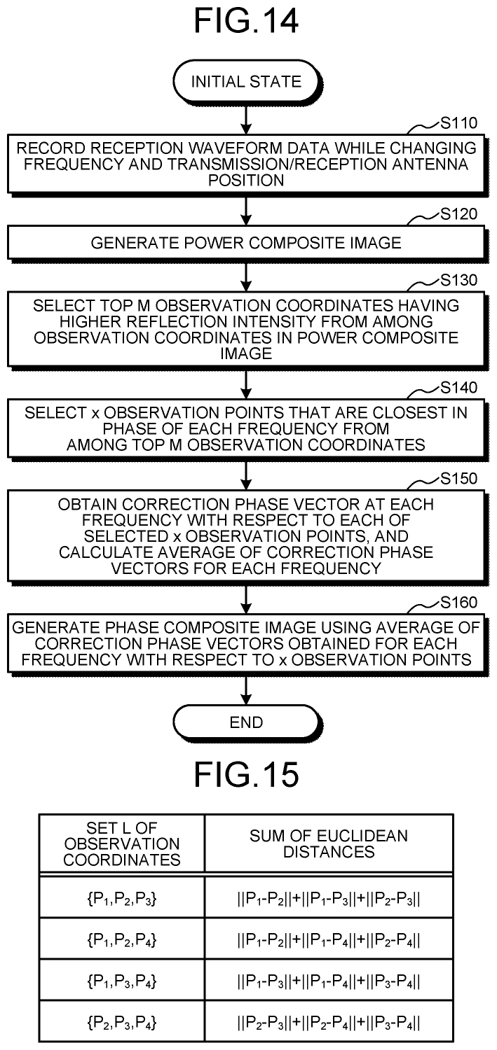

Next, the third embodiment will be described with reference to FIG. 14. The third embodiment is different from the first and second embodiments in the procedure for calculating the correction phase in the correction phase calculation unit 27.

The object scanning device according to the third embodiment may be either the object scanning device 10A or the object scanning device 10B. In the following description, a case where the object scanning device according to the third embodiment is the object scanning device 10A will be described.

FIG. 14 is a flowchart illustrating a procedure for generating a phase composite image by the object scanning device according to the third embodiment. The object scanning device 10A receives reflected waves while changing the frequency and the transmission/reception antenna position, and records reception waveform data that is information of reflected waves (step S110) through the same processing as in step S10 described in the first embodiment.

The power composite image generation unit 26 generates a power composite image (step S120) through the same processing as in step S20 described in the first embodiment.

The correction phase calculation unit 27 selects top M (M is a natural number of two or more) observation coordinates having higher reflection intensity from among the coordinates of the observation points in the power composite image output from the power composite image generation unit 26, that is, the observation coordinates (step S130). For the selected M observation coordinates, the correction phase calculation unit 27 calculates a correction phase Arg(cₙ(λₖ)) (n=1, . . . , and M, k=1, . . . , and K) at each frequency from the reception waveform data, frequency data, and position data recorded in the waveform recording unit 22. Here, K represents the number of frequencies used for observation.

The correction phase calculation unit 27 defines a correction phase vector Pₙ (n=1, . . . , and M) having the correction phase Arg(cₙ(λₖ)) at each frequency as an element, as expressed by Formula (6) below.

Formula 6:

Pₙ=(Arg(cₙ(λ₁))Arg(cₙ(λ₂)) . . . Arg(cₙ(λ_{K}))) (6)

The correction phase calculation unit 27 extracts x (x is a natural number of M or less) observation coordinates from among the selected M observation coordinates. The correction phase calculation unit 27 obtains the Euclidean distance between correction phase vectors for ₁C₂ combinations of two observation coordinates selected from a set L of the extracted x observation coordinates. The correction phase calculation unit 27 calculates the sum of Euclidean distances.

The correction phase calculation unit 27 calculates the sum of Euclidean distances for all the _{M}Cₓ combinations, and selects a combination having the smallest sum of Euclidean distances between correction phase vectors. That is, the correction phase calculation unit 27 selects x observation points that are closest in the phase of each frequency from among the top M observation coordinates (step S140).

The correction phase calculation unit 27 calculates the average of the correction phase vectors of the selected observation points. That is, the correction phase calculation unit 27 obtains the correction phase vector at each frequency with respect to each of the selected x observation points, and calculates the average of the correction phase vectors for each frequency (step S150).

In this manner, the correction phase calculation unit 27 extracts top M observation coordinates, and extracts x observation coordinates that form a combination having the smallest phase difference of each frequency from among the combinations of x observation coordinates included in the top M observation coordinates. Furthermore, the correction phase calculation unit 27 calculates the average of the phases of each frequency as a correction phase with respect to the extracted x observation coordinates.

The correction phase calculation unit 27 sets the calculated average of the correction phase vectors as the correction phase at each frequency to be output to the phase composite image generation unit 28. The correction phase calculation unit 27 generates a phase composite image using the correction phase (average of correction phase vectors) obtained for each frequency with respect to the x observation points (step S160). Note that x may be the same value as M.

FIG. 15 is a diagram for explaining combinations that are sets of observation coordinates and the sum of Euclidean distances in each combination calculated by the object scanning device according to the third embodiment. FIG. 15 depicts, given M=4 and x=3, combinations that are sets L of observation coordinates and the sum of Euclidean distances in each combination expressed by an equation.

As described above, according to the third embodiment, since the object scanning device 10A can use information of a plurality of observation points to calculate the correction phase, it is possible to stably obtain the correction phase as compared with the first and second embodiments.

Here, the hardware configuration of the object scanning devices 10A and 10B will be described. Because the object scanning devices 10A and 10B have the same hardware configuration, the hardware configuration of the object scanning device 10A according to the first embodiment will be described below.

In the object scanning device 10A according to the first embodiment, the quadrature detection unit 21, the waveform recording unit 22, the frequency control unit 23, the high frequency signal generation unit 24, the position control unit 25, the power composite image generation unit 26, the correction phase calculation unit 27, and the phase composite image generation unit 28 are implemented by processing circuitry. The processing circuitry may be a memory and a processor that executes a program stored in the memory, or may be dedicated hardware. The processing circuitry is also called a control circuit.

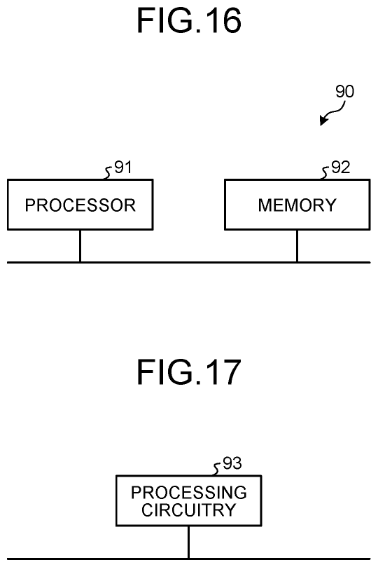

FIG. 16 is a diagram illustrating an exemplary configuration of processing circuitry in the case that the processing circuitry provided in the object scanning device according to the first embodiment is implemented by a processor and a memory. The processing circuitry 90 illustrated in FIG. 16 is a control circuit and includes a processor 91 and a memory 92. In a case where the processing circuitry 90 is configured with the processor 91 and the memory 92, each function of the processing circuitry 90 is implemented by software, firmware, or a combination of software and firmware. Software or firmware is described as a program and stored in the memory 92. In the processing circuitry 90, the processor 91 reads and executes the program stored in the memory 92, thereby implementing each function. That is, the processing circuitry 90 includes the memory 92 for storing a program that results in the execution of processing of the object scanning device 10A. It can also be said that this program is a program for causing the object scanning device 10A to execute each function implemented by the processing circuitry 90. This program may be provided by a storage medium in which the program is stored, or may be provided by other means such as a communication medium.

It can also be said that the above program is a program for causing the object scanning device 10A to execute the processing of steps S10 to S50 in FIG. 12. That is, it can be said that the above program is a program for causing the object scanning device 10A to execute a step of recording reception waveform data, a step of generating a power composite image, a step of searching for maximum reflection intensity coordinates, a step of calculating the phase of the correlation vector at the maximum reflection intensity coordinates as a correction phase, and a step of generating a phase composite image using the correction phase.

The processor 91 is exemplified by a central processing unit (CPU), a processing device, an arithmetic device, a microprocessor, a microcomputer, or a digital signal processor (DSP). Examples of the memory 92 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

FIG. 17 is a diagram illustrating an example of processing circuitry in the case that the processing circuitry provided in the object scanning device according to the first embodiment is implemented by dedicated hardware. For example, the processing circuitry 93 illustrated in FIG. 17 is a single circuit, a composite circuit, a programmed processor, a parallel programmed processor, an application specific integrated circuit (ASIC), a field-programmable gate array (FPGA), or a combination thereof. The processing circuitry 93 may be partially implemented by dedicated hardware, and partially implemented by software or firmware. In this manner, the processing circuitry 93 can implement the above-described functions using dedicated hardware, software, firmware, or a combination thereof.

The object scanning device according to the present disclosure can achieve the effect of accurately scanning an object with a simple configuration even under an environment where an accurate distance to the object cannot be measured.

The configurations described in the above-mentioned embodiments indicate examples. The embodiments can be combined with another well-known technique and with each other, and some of the configurations can be omitted or changed in a range not departing from the gist.

What is claimed is:

1. An object scanning device that generates an image of an object that is a measurement subject disposed in a measurement area based on reflected waves of radio waves including a plurality of frequencies radiated to the object comprising:
phase composite image generation circuitry to generate a phase composite image into which a plurality of images are composed by performing complex addition for each pixel of the plurality of images, the plurality of images being obtained through imaging based only on the reflected waves having frequencies same as the frequencies included in the radio waves radiated;
power composite image generation circuitry to generate a power composite image into which images of the object at the frequencies are composed by using an imaging method with a matched filter of power composing type that involves integrating, for each pixel, correlation vectors indicating a correlation between estimated waveforms of the reflected waves and reception waveform data based on the reception waveform data, position data, and frequency data, the reception waveform data being data of waveforms of the reflected waves emitted from a transmission antenna, reflected by the object, and received by a reception antenna, the position data indicating a position of the transmission antenna and the reception antenna with respect to the object, the frequency data being data of the frequencies of radio waves emitted from the transmission antenna; and
correction phase calculation circuitry to execute, based on the power composite image, the reception waveform data, the position data, and the frequency data, searching the power composite image for an observation coordinate indicating a reflection intensity larger than a specific value, and calculating a phase of the correlation vectors at the observation coordinate as a correction phase to be used for phase correction when the phases of the images are composed, wherein
the phase composite image generation circuitry generates the phase composite image into which images of the object at the frequencies are composed by using an imaging method with a matched filter of phase composing type that involves performing complex addition of the correlation vectors for each pixel based on the correction phase, the reception waveform data, the position data, and the frequency data.

2. The object scanning device according to claim 1, wherein
when generating the phase composite image, the phase composite image generation circuitry subtracts the correction phase for each of the frequencies from a phase offset of the correlation vectors, and performs complex addition of the correlation vectors for each pixel.

3. The object scanning device according to claim 1, wherein
the correction phase calculation circuitry searches for maximum reflection intensity coordinate indicating a maximum reflection intensity from among the observation coordinates included in the power composite image, and calculates a phase of each of the frequencies at the maximum reflection intensity coordinate as the correction phase.

4. The object scanning device according to claim 1, wherein
the correction phase calculation circuitry selects a plurality of top observation coordinates having larger reflection intensity from among the observation coordinates included in the power composite image, and calculates, as the correction phase, an average of phases of each of the frequencies at the plurality of top observation coordinates.

5. The object scanning device according to claim 4, wherein
the correction phase calculation circuitry extracts, from among a plurality of observation coordinates included in the plurality of top observation coordinates, a plurality of observation coordinates that form a combination having a smallest phase difference of each of the frequencies, and calculates, as the correction phase, an average of phases of each of the frequencies at the plurality of observation coordinates extracted.

6. The object scanning device according to claim 1, wherein
the radio waves are signals in a sub-terahertz to terahertz range.

7. A control circuit that generates an image of an object that is a measurement subject disposed in a measurement area based on reflected waves of radio waves including a plurality of frequencies radiated to the object, the control circuit causing an object scanning device that scans the object to execute:
generating a phase composite image into which a plurality of images are composed by performing complex addition for each pixel of the plurality of images, the plurality of images being obtained through imaging based only on the reflected waves having frequencies same as the frequencies included in the radio waves radiated;
generating a power composite image into which images of the object at the frequencies are composed by using an imaging method with a matched filter of power combining type that involves integrating, for each pixel, correlation vectors indicating a correlation between estimated waveforms of the reflected waves and reception waveform data based on the reception waveform data, position data, and frequency data, the reception waveform data being data of waveforms of the reflected waves emitted from a transmission antenna, reflected by the object, and received by a reception antenna, the position data indicating a position of the transmission antenna and the reception antenna with respect to the object, the frequency data being data of the frequencies of radio waves emitted from the transmission antenna; and
based on the power composite image, the reception waveform data, the position data, and the frequency data, searching the power composite image for observation coordinates indicating a reflection intensity larger than a specific value, and calculating a phase of the correlation vectors at the observation coordinates as a correction phase to be used for phase correction when the phases of the images are composed, wherein
in the generating the phase composite image, the phase composite image into which images of the object at the frequencies are composed is generated by using an imaging method with a matched filter of phase composing type that involves performing complex addition of the correlation vectors for each pixel based on the correction phase, the reception waveform data, the position data, and the frequency data.

8. A non-transitory computer readable storage medium storing a program for generating an image of an object that is a measurement subject disposed in a measurement area based on reflected waves of radio waves including a plurality of frequencies radiated to the object, the program causing an object scanning device that scans the object to execute:
generating a phase composite image into which a plurality of images are composed by performing complex addition for each pixel of the plurality of images, the plurality of images being obtained through imaging based only on the reflected waves having frequencies same as the frequencies included in the radio waves radiated;
generating a power composite image into which images of the object at the frequencies are composed by using an imaging method with a matched filter of power composing type that involves integrating, for each pixel, correlation vectors indicating a correlation between estimated waveforms of the reflected waves and reception waveform data based on the reception waveform data, position data, and frequency data, the reception waveform data being data of waveforms of the reflected waves emitted from a transmission antenna, reflected by the object, and received by a reception antenna, the position data indicating a position of the transmission antenna and the reception antenna with respect to the object, the frequency data being data of the frequencies of radio waves emitted from the transmission antenna; and
based on the power composite image, the reception waveform data, the position data, and the frequency data, searching the power composite image for observation coordinates indicating a reflection intensity larger than a specific value, and calculating a phase of the correlation vectors at the observation coordinates as a correction phase to be used for phase correction when the phases of the images are composed, wherein
in the generating the phase composite image, the phase composite image into which images of the object at the frequencies are composed is generated by using an imaging method with a matched filter of phase composing type that involves performing complex addition of the correlation vectors for each pixel based on the correction phase, the reception waveform data, the position data, and the frequency data.

9. An object scanning method for generating an image of an object that is a measurement subject disposed in a measurement area based on reflected waves of radio waves including a plurality of frequencies radiated to the object, the object scanning method comprising:
generating, by a control circuit, a phase composite image into which a plurality of images are composed by performing complex addition for each pixel of the plurality of images, the plurality of images being obtained through imaging based only on the reflected waves having frequencies same as the frequencies included in the radio waves radiated;
generating a power composite image into which images of the object at the frequencies are composed by using an imaging method with a matched filter of power composing type that involves integrating, for each pixel, correlation vectors indicating a correlation between estimated waveforms of the reflected waves and reception waveform data based on the reception waveform data, position data, and frequency data, the reception waveform data being data of waveforms of the reflected waves emitted from a transmission antenna, reflected by the object, and received by a reception antenna, the position data indicating a position of the transmission antenna and the reception antenna with respect to the object, the frequency data being data of the frequencies of radio waves emitted from the transmission antenna; and
performing, based on the power composite image, the reception waveform data, the position data, and the frequency data, searching the power composite image for observation coordinates indicating a reflection intensity larger than a specific value, and calculating a phase of the correlation vectors at the observation coordinates as a correction phase to be used for phase correction when the phases of the images are composed, wherein
in the generating the phase composite image, the phase composite image into which images of the object at the frequencies are composed is generated by using an imaging method with a matched filter of phase composing type that involves performing complex addition of the correlation vectors for each pixel based on the correction phase, the reception waveform data, the position data, and the frequency data.
